(19) United States
(12) Patent Application Publication
(10) Pub. No.: US 2008/0017182 A1
(43) Pub. Date: Jan. 24, 2008

(54) Vehicle-mounted hydraulic slab cutter

(76) Inventor: Troy Hilsgen, Kimball, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/805,838

(22) Filed: May 24, 2007

Related U.S. Application Data
(60) Provisional application No. 60/810,375, filed on Jun. 2, 2006.

(51) Int. Cl. B28D 1/04

(52) U.S. Cl. 125/13.01; 125/12

(57) ABSTRACT

A vehicle-mounted cutter for cutting a paved surface such as concrete is disclosed. The cutter utilizes the hydraulic power from a vehicle to operate a saw motor that rotates a blade operably attached to a trolley, an orbital motor that engages causes the trolley to move along a boom, and an hydraulic cylinder that determines the depth of the rotary saw relative to the boom. Using a control box that controls the flow rate of hydraulic fluid, an operator can adjust the travel speed of the trolley and the depth of the rotary saw.

### RELATED APPLICATION

The present application claims the benefit of U.S. Provisional Application No. 60/810,375, filed Jun. 2, 2006, which is incorporated herein in its entirety by reference.

### FIELD OF THE INVENTION

The present invention relates to slab cutters. More particularly, the present invention relates to a hydraulically controlled apparatus that can be mounted onto a skid-steer loader for cutting paved surfaces.

### BACKGROUND OF THE INVENTION

Slabs used to form paved surfaces such as streets, curbs, sidewalks, and driveways generally must be made from highly durable materials that are able to withstand heavy and frequent traffic. Materials such as concrete, asphalt, masonry, and stonework are well-suited for such applications because of their relatively high hardness. For a variety of reasons, it is often necessary to cut these materials after they have been set into place. In such situations, the relative hardness of the materials from which the surfaces are made and other factors can significantly increase the difficulty of effecting cuts.

A common situation in which a surface requires cutting is when concrete has been poured and begins to cure. As concrete cures, it typically contracts approximately one-sixteenth of an inch for every ten feet of concrete poured. This contraction can cause irregular cracking that will diminish the performance, longevity, and aesthetic appeal of the surface. When concrete is used in forming relatively large slabs, such as sidewalks or streets, cracking is a virtually certainty.

The cracking that occurs once concrete is poured can, however, be controlled by cutting grooves, or control joints, into the concrete at regular or semi-regular intervals before the concrete completely cures. Generally, these control joints act as pre-weakened stress points that encourage the concrete to crack along the control joints during the curing process. As a result, cracking that occurs can be contained to grooves of regularly spaced control joints.

Concrete, as well as other materials used to form paved surfaces, may also require cutting for other purposes. Road repair, for example, often requires discrete segments or areas of a paved surface to be removed or replaced. Similarly, damaged or outdated utilities buried under roadways typically cannot be repaired or replaced unless portions of the roadway are first removed. In other instances, demolition, construction, or reconfiguration of paved surfaces such as parking lots, patios, streets, and sidewalks require that portions or segments of these surfaces be removed.

A number of saws, or cutters, have been developed that cut paved surfaces made from concrete and other relatively hard materials. These tools offers several advantages including minimizing damage to portions of the surface that are not to be removed, reducing the risk of disrupting or harming buried utility lines, preserving intact a large portion of the surface that has been cut out, and facilitating post-project restoration of the site. Most such cutters affect a desired cut using a rotating blade that is moved transversely across the paved surface at a particular depth. Some cutters (e.g., hand-held cutters) have a self-powered rotary saw that requires an operator to effect a cut by pushing and guiding the cutter across the paved surface. Other types of self-powered cutters (e.g., walk-behind cutters) include a gear-and-motor system that propels the cutter while still relying upon an operator for guidance. A significant benefit of hand-held and walk-behind cutters is their independence from separate machines for power, support, and propulsion. Examples of hand-held and walk-behind cutters include U.S. Pat. No. 4,236,356 to Ward, which discloses a hand-held cutter that can be operated by a left-handed or a right-handed person, and U.S. Pat. No. 5,803,071 to Chiuminatta, et al., which discloses a walk-behind cutter for cutting grooves into soft, or curing, concrete as the apparatus is propelled by a user.

Though relatively transportable because of their size, hand-held and walk-behind cutters have a number of disadvantages. They can be extremely labor intensive, requiring significant expenditures of time or exertion that can quickly tire an operator of the machine. Hand-held and walk-behind cutters are also usually propelled or steered directly by the operator. This places the operator in close proximity to the rotary saw of the concrete cutter and increases the risk of injury to the operator. Reliance upon the operator for propulsion or guidance can also increase the likelihood of irregularities along the cutting path. Furthermore, because hand-held and walk-behind cutters function optimally when supported by the surface in which a cut is to be made, an operator must typically begin the cut in the surface, continue cutting until reaching an edge, and then turn the cutter around to finish the cut to the opposite edge. This process inherently involves difficult alignment and realignment procedures that require the operator to attempt to position the cutter so that the initial cut and the finishing cut form a single, linear cut. Hand-held and walk-behind cutters are further limited by their inability to be effectively maneuvered over curing concrete and surfaces such as sod, loose or rocky dirt, or muddy terrain.

Many of the problems associated with operating a hand-held or walk-behind cutter can be solved by using a type of cutter that can be linked to a vehicle or other piece of equipment. Typically, the vehicle or other piece of equipment provides power, propulsion, guidance, support, or a combination thereof. Because these types of attachable cutters are typically larger than hand-held or walk-behind cutters, they often incorporate guidance systems whereby a rotary saw follows a stationary track, such as a set of rails.

Attachable cutters provide a number of advantages over hand-held and walk-behind cutters. In addition to addressing many of the aforementioned problems of hand-held and walk-behind cutters, attachable cutters can utilize the hydraulic systems offered by certain types vehicles to provide greater power to the rotary saw. By eliminating the requirement that an operator manually propel or guide the entire cutter apparatus while making a cut, attachable cutters can also incorporate additional features that would compromise the maneuverability and overwhelm the power-generating capabilities of typical hand-held and walk-behind cutters. Examples of attachable and self-guided cutters include the inventions disclosed by the following U.S. patents, the disclosures of which are herein incorporated by reference in their entirety: U.S. Pat. No. 6,863,062 to Denys; U.S. Pat. No. 6,422,228 to Latham; U.S. Pat. No. 6,293,269 to Selb, et al.; U.S. Pat. No. 6,286,905 to Kimura, et al.; U.S. Pat. No. 6,203,112 to Cook, et al.; U.S. Pat. No. 5,724,956 to Ketterhagen, et al.; U.S. Pat. No. 5,676,125 to Kelly, et al.; U.S. Pat. No. 5,125,071 to Mertes, et al.; U.S. Pat. No. 5,135,287 to Karnes; U.S. Pat. No. 4,832,412 to Bertrand; U.S. Pat. No. 4,557,245 to Bieri; U.S. Pat. No. 4,353,275 to Colville; U.S. Pat. No. 4,310,198 to Destree; U.S. Pat. No. 4, 134,459 to Hotchen; U.S. Pat. No. 4,054,179 to Destree; U.S. Pat. No. 3,785,705 to Binger; U.S. Pat. No. 3,779,609 to James; U.S. Pat. No. 3,649,071 to Graff; and U.S. Pat. No. 3,378,307 to Dempsey, et al.

Despite the many benefits provided by attachable cutters, they also have several disadvantages. Attachable cutters can be difficult to transport and mount or attach to the proper vehicle or equipment. Many attachable cutters also require that the cutter be supported or otherwise placed upon the surface being cut, which can harm or mar the surface being cut especially soft surfaces such as curing concrete or asphalt subject to elevated temperatures. Attachable cutters are limited in their ability to control the depth of the rotating blade, lacking an ability to independently increase or decrease the depth of the rotary saw while maintaining the position, orientation, and stability of the cutter. Attachable cutters are generally ineffective in adjusting the rate at which the rotary saw traverses the surface being cut. Differences in the thickness, density, moisture content, internal temperature, and hardness of different surfaces can affect the optimum speed at which the cutter should traverse the surface being cut. Without a corresponding ability to adjust speeds, project-completion times may be unnecessarily delayed, dulling of the blade of the rotary saw may be accelerated, and excessive chipping or cracking may occur.

Therefore, there is a need for a cutter that can be attached to and derive power from a common work-site vehicle such as a skid-steer loader, or other type of vehicle or piece of equipment, and is capable of cutting different types of surfaces at different speeds and at different depths.

### SUMMARY OF THE INVENTION

The present invention provides a novel attachment for a front-end loader, such as a skid-steer loader. Specifically, the present invention enables the operator of a skid-steer loader to transport, position, guide, and otherwise operate a cutter in cutting a paved surfaced made from concrete, asphalt, masonry, stone, or similar material. The present invention guides a rotary saw attached to a trolley to make cuts. As the blade of the rotary saw spins, an operator uses the hydraulic controls of the skid-steer loader to move the trolley along a boom extending outwardly from the skid-steer loader. A feature and advantage of the present invention is that the rate at which trolley moves along the boom and the depth of the rotary cutting blade relative to the boom can be controlled by the operator.

The present invention has a hydraulic control system that taps into the hydraulic flow generated by the skid-steer loader. Specifically, hydraulic fluid is directed from the skid-steer loader to a flow divider. The flow divider divides the flow into a primary flow and a secondary flow. The primary flow is directed to a saw motor that drives the rotary saw and is then returned to the skid-steer loader. The secondary flow is directed into a flow control device in electrical communication with a control box mounted in the cab of the skid-steer loader. The flow control device selectively adjusts the rate of hydraulic flow to a dual-spool control valve. The control valve selectively divides the controlled flow through a pair of circuits. One of the circuits carries hydraulic fluid to an orbital motor responsible for the rate at which the trolley travels along the boom. The other circuit caries hydraulic fluid to a hydraulic cylinder responsible for the depth of the rotary saw relative to the boom and the surface being cut. An operator can thereby control the speed and direction of the trolley and the depth and rate of depth control of the rotary saw.

In operation, these features allow an operator of the present invention to quickly and repeatedly effect uniform cuts in a paved surface. Specifically, the operator can position the skid-steer loader at the edge of a paved surface, such as a sidewalk. Using the lift arms of the skid-steer loader, the operator can lower the boom over the paved surface while extending the trolley to a distal point on the boom. To ensure a uniform cut, jack stands located at or near opposite ends of the boom can assist in stabilizing the boom so that it remains substantially parallel to the top of the paving surface. The operator can then set the depth at which the rotary cutting blade will be positioned within the paved surface and the speed at which the rotary cutting blade will travel through the paved surface. Once the boom is lowered into position, the operator can begin retracting the trolley—which is attached to the rotary saw—to cut the paved surface in a straight line toward the skid-steer loader. When the trolley reaches the proximal end of the boom, or some other point determined by the user, the operator can simultaneously reposition the skid-steer loader for an additional cut, use the lift arms of the skid-steer loader to again raise the boom, and extend the trolley to a distal point on the boom. Repeating this process, the operator can utilize the present invention to efficiently perform cutting tasks such as, for example, cutting control joints in curing concrete, creating a design in curing or cured concrete, or cutting a pattern into a street so that asphalt can be removed to expose utility lines.

Although the present invention is generally described in relation to a cutter that can be mounted to a skid-steer loader and used to cut concrete, the present invention can also be mounted to any number of vehicles or appropriate pieces of equipment and cut any number of surface without departing from the spirit and scope of the present invention.

The above summary of the present invention is not intended to describe each embodiment or every implementation of the present invention. The figures and the detailed description that follow more particularly exemplify these embodiments.

### BRIEF DESCRIPTION OF THE DRAWINGS

FIG. 1 is a side view of a concrete cutter mounted to skid-steer loader according to an embodiment of the present invention.

FIG. 2 is a perspective view of a concrete cutter according to an embodiment of the present invention.

FIG. 3 is a top view of a concrete cutter according to an embodiment of the present invention.

FIG. 4 is a perspective view of a concrete cutter mounted to skid-steer loader according to an embodiment of the present invention.

FIG. 5 is a front view of a trolley of the present invention.

FIG. 6 is a side view of a trolley of the present invention.

FIG. 7 is a perspective view of a trolley of the present invention.

FIG. 8 is a schematic illustration of the hydraulic flow of the present invention.

FIG. 9 is a perspective view of a concrete cutter according to an embodiment of the present invention in which gear reduction is accomplished by first and second reduction gears.

FIG. 10 is a perspective view of a gear reduction mechanism according to an embodiment of the present invention in which gear reduction is accomplished by first and second reduction gears.

FIG. 11 is a perspective view of a portion of distal end of a boom according to an embodiment of the present invention.

FIG. 12 is a perspective view of a cutter according to an embodiment of the present invention having a gear reduction mechanism in which gear reduction motor is accomplished by a gear box.

FIG. 13 is a perspective view of a cutter according to an embodiment of the present invention cutter having gear reduction mechanism in which gear reduction is accomplished by a gear box.

FIG. 13 is a magnified partial perspective view of gear reduction mechanism according to an embodiment of the present invention in which gear reduction is accomplished by a gear box.

### DETAILED DESCRIPTION

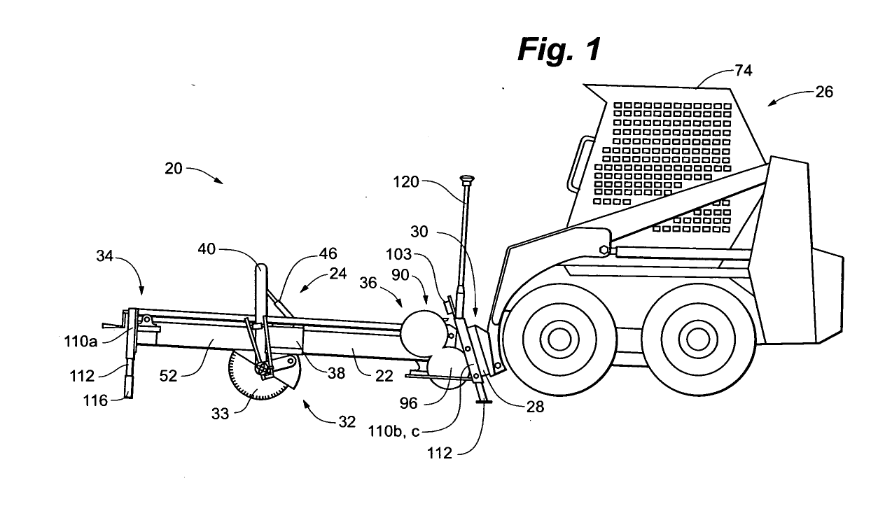

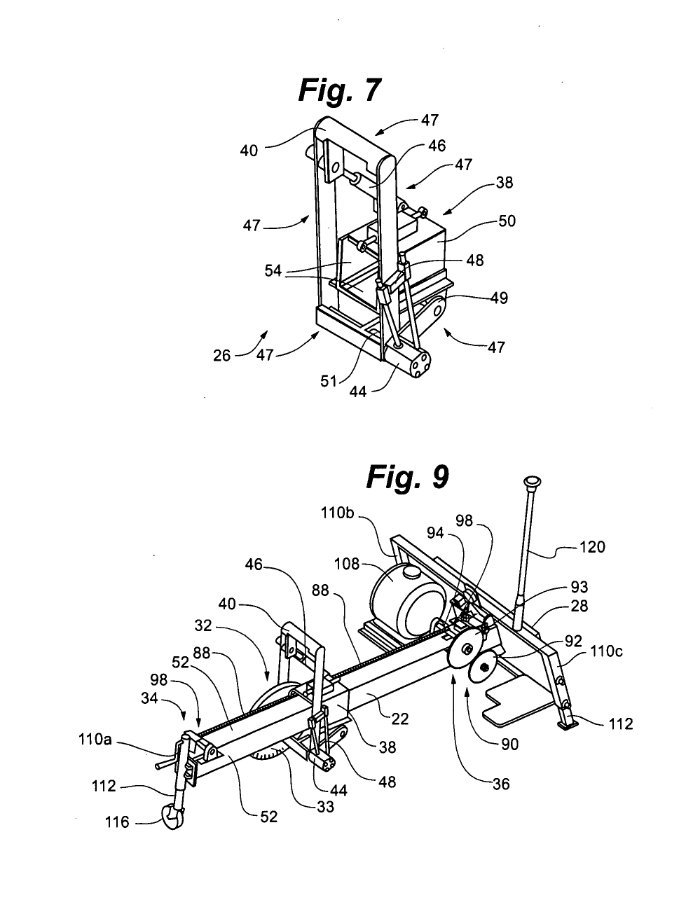

The present invention can be more readily understood by reference to FIGS. 1-11 and the following description. While the present invention is not necessarily limited to such an application, the present invention will be better appreciated using a discussion of exemplary embodiments in such a specific context.

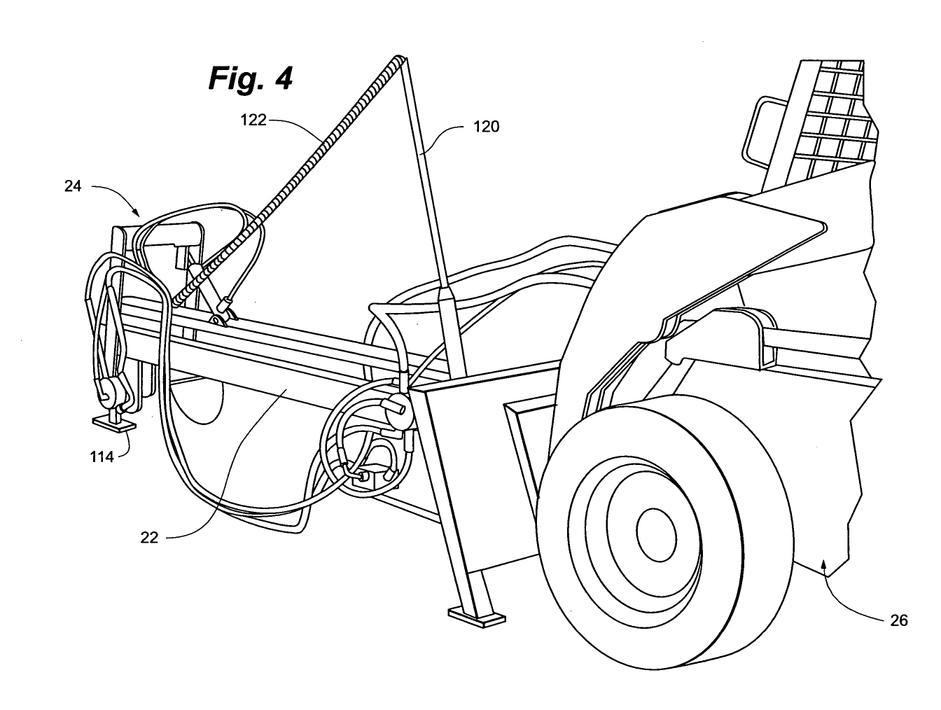

Referring to FIGS. 1-4, cutter 20 comprises boom 22 and trolley 24 in an exemplary embodiment. Referring to FIGS. 1 and 4, cutter 20 is attached to skid-steer loader 26 with attachment plate 28 secured at attachment area 30 of skid-steer loader 26. Generally, cutter 20 cuts a paved surface, such as, for example, a concrete sidewalk, as trolley 24 carrying rotary saw 32 moves along boom 22 from distal end 34 to proximal end 36.

Boom 22 generally extends outward from skid-steer loader 26, as depicted in FIGS. 1-4. In an exemplary embodiment, boom 22 is mounted to the front of skid-steer loader 26. Referring to FIG. 1, boom 22 may be secured to skid-steer loader 26 with attachment plate 28. Attachment plate 28 interfaces with boom 22 at proximal end 36 and with skid-steer loader 26 at attachment area 30.

Since cutter 20 executes a cut as trolley-mounted rotary saw 32 moves from distal end 34 to proximal end 36 of boom 22, boom 22 defines the path of the cut. Generally, boom 22 is substantially linear between distal end 34 and proximal end 36. In an exemplary embodiment, boom 22 is mounted at or near the center of attachment area 30 and perpendicular to the plane defining the front of skid-steer loader 26. To support the weight of trolley 24, maintain a consistent shape through repeated use, and resist fatigue, boom 22 should be made of a substantially rigid material. In an exemplary embodiment, boom 22 is made of steel.

The material from which boom 22 is made may be formed into any number of shapes to facilitate travel of and support trolley 24. In an exemplary embodiment, boom 22 has a substantially square cross section, depicted in FIGS. 1-4. In other embodiments, boom 22 is constructed such that a cross section of boom 22 forms other geometric configurations such as, for example, a circle, a triangle, or an I-shape.

Boom 22 may include several features or components that enhance the performance of cutter 20. For example, the ability of cutter 20 to effect straight cuts at a uniform depth in a paved surface can be increased by stabilizing distal end 34 of boom 22. By limiting horizontal and vertical movement of cutter 20 during operation, an operator can achieve straighter cuts at a more uniform depth, thereby optimizing operation of cutter 20. To stabilize boom 22 when boom 22 is lowered into a cutting position, cutter 20 may be equipped with jack stand 110. Referring to FIGS. 1-4 and 9, cutter 20 may have front jack stand 110a located near distal end 34 of boom 22 and rear jacks stands 110b,c located near proximal end 36 of boom 22. Generally, jack stands 110 have extendable member 112 that be raised or lowered so that foot 114 rests on the ground or other surface. Front jack stand 110a may also have wheel 116, as depicted in FIGS. 1-2 and 9.

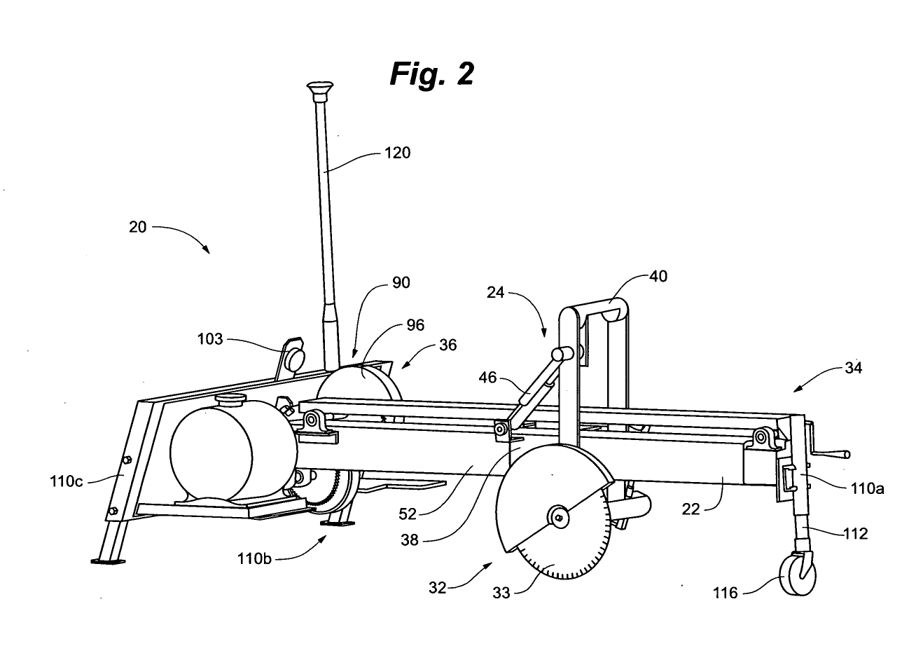

Jack stands can be manually operated, hydraulically operated, or operated through a combination thereof. Referring to FIG. 2, front jack stand 110a is manually operated and rear jack stands 110b,c are hydraulically operated. In another embodiment, front jack stand 110a is hydraulically operated and rear jack stands 110b,c are manually operated. In another embodiment, front jack stand 110a and rear jack stands 110b,c are both manually operated. In another embodiment, front jack stand 110a and rear jack stands 110b,c are both hydraulically operated. In embodiments in which jack stands 110 are manually operated, jack stands 110 can be operated by, for example, rotating a lever that actuates a lift mechanism. In embodiments in which jack stands 110 are hydraulically operated, jack stands 110 can be operated by, for example, manipulating a control mechanism mounted in cab 74 of skid-steer loader 26. In other embodiments in which jack stands 110 are hydraulically operated, cutter 20 may include a self-leveling system for adjusting the height of jack stands 110 relative to the surface being cut.

The ability to adjust the height of jack stands 110 allows cutter 20 to be easily adapted to rest on support surfaces having different levels relative to the level of the paving surface being cut. For example, curing concrete being be cut for control joints in a sidewalk may present a support surface adjacent to the sidewalk that is not yet back-filled. Cured concrete being cut for sidewalk removal purposes, however, may a present an adjacent support surface that has already been backfilled. To create linear cuts at a uniform depth, cutter 20 should have an ability to be variably stabilized on the different levels of the various support surfaces relative to the sidewalk. In an exemplary embodiment, cutter 20 has front jack stand 110a located at distal end 34 of boom 22 and two rear jack stands 110b, c located on opposite ends of attachment plate 28 at proximal end of boom 36. In other embodiments, cutter 20 only has front jack stand 110a located at distal end 34 of boom 22.

Although the embodiments of cutter 20 described above have boom 22 extending outward from skid-steer loader 26, other embodiments may include boom 22 oriented in a different direction. For example, cutter 20 can be configured so that boom 22 is oriented transverse to the fore-aft axis of skid-steer loader 26, or, in other words, substantially transverse with a side of skid-steer loader 26. Such a configuration permits an operator to maneuver skid-steer loader 26 parallel to a paved surface while making cuts in the paved surface at a desired interval. Alternatively, boom 22 can be attached to skid-steer loader 26 such that boom 22 is able to pivot between a transverse orientation and an extended orientation.

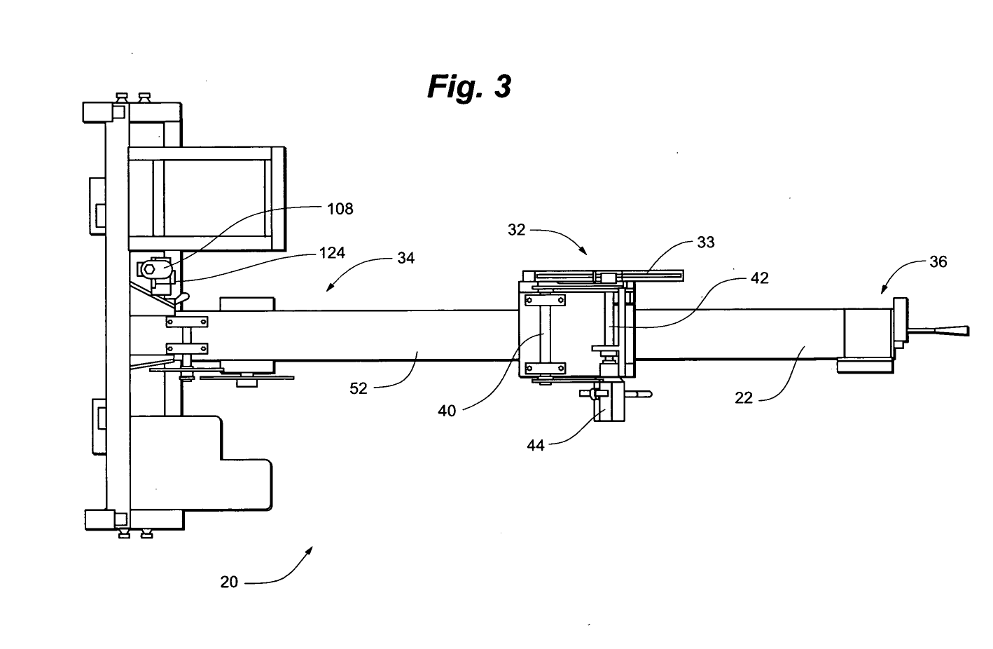

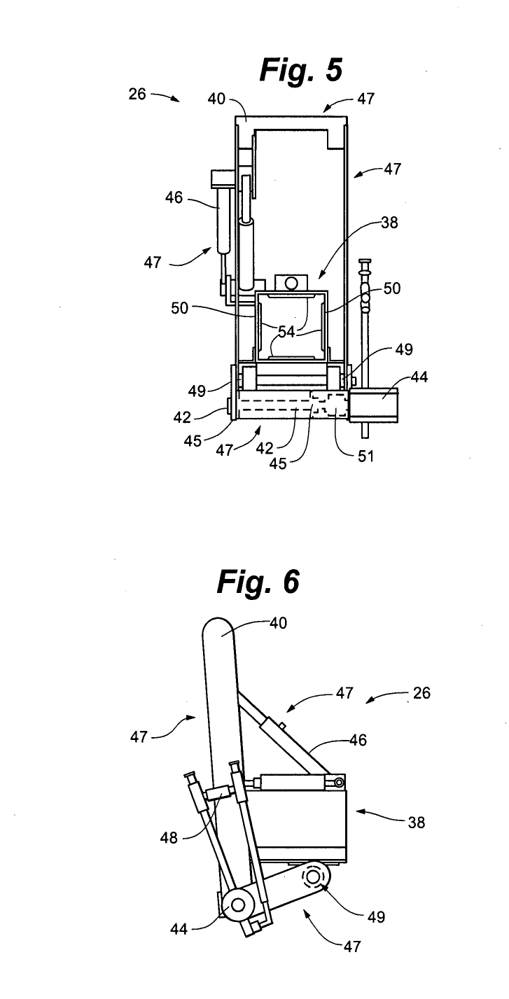

Referring to FIGS. 5-7, trolley 24 has boom housing 38, arbor 40, arbor shaft 42, saw motor 44, hydraulic cylinder 46, and hydraulic check valve 48, in an exemplary embodiment. Generally, boom housing 38 is constructed around boom 22. Although boom housing 38 and boom 22 may have any number of shapes, boom housing 38 and boom 22 are substantially square in an exemplary embodiment, as depicted in FIGS. 3 and 5-7. Boom housing 38 fits snugly around boom 22 so that the interior surfaces of boom housing walls 50 are substantially coextensive with a portion of the exterior surfaces of boom walls 52. Boom housing 38 is thereby selectively positioned on and secured to boom 22. Since boom 22 and boom housing 38 are typically made of steel, boom housing walls 50 may be lined with a non-frictional material. In an exemplary embodiment, plates 54 made of a polymer such as perlon or nylon material are disposed or otherwise fixed to boom housing walls 38. In another embodiment, plates 54 are disposed or otherwise fixed to boom walls 52. Plates 54 facilitate the sliding of boom housing 38 along boom 22 by decreasing the friction between boom housing walls 50 and boom walls 52. Because boom housing 38 moves coextensively along boom 22, the distance boom housing 38 is able to travel is defined by the length of boom 22. Plates 54 can also be fitted loosely between boom housing walls 50 and boom walls 52. Such that plates 54 may be readily replaced when worn.

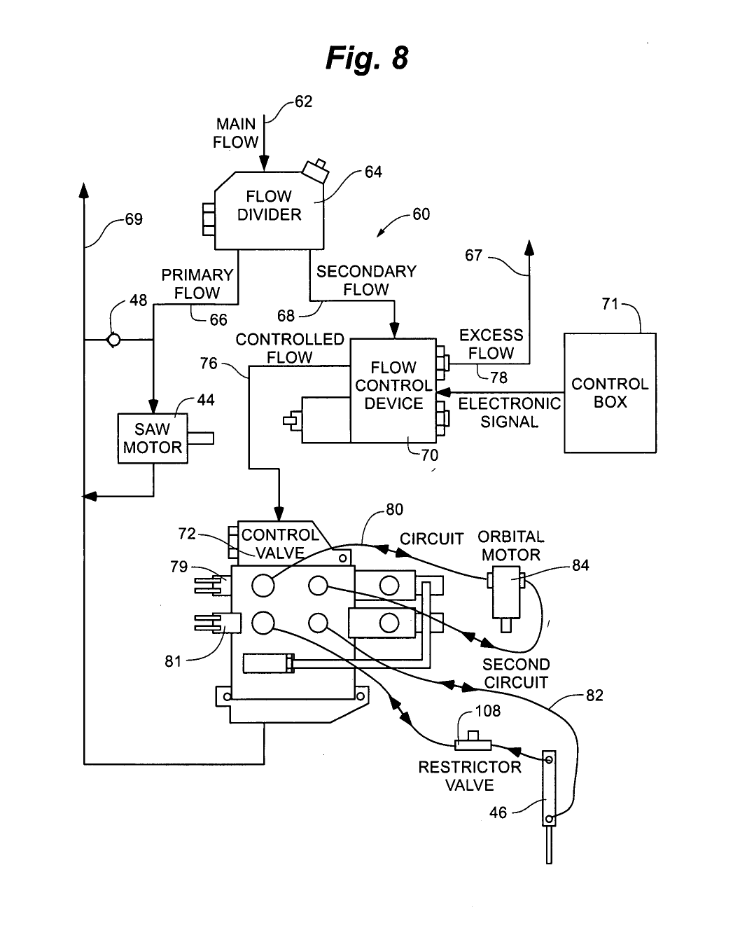

Cutter 20 is able to makes cuts in a paved surface by using hydraulic power from skid-steer loader 26 to power rotary saw 32 having blade 33. Referring to FIG. 8, a schematic illustration of hydraulic control system 60 shows the flow path of the hydraulic fluid used to power cutter 20 in an exemplary embodiment. Generally, hydraulic control system 60 supports and substantially maintains a flow rate in the range of about fifteen gallons per minute to about twenty-five gallons per minute. In an exemplary embodiment, hydraulic control system 60 supports and substantially maintains a flow rate in the range of about twenty gallons per minute. The various components of hydraulic control system 60 may be linked in any number of ways. In an exemplary embodiment, the various components of hydraulic system are linked with hydraulic hoses.

Generally, skid-steer loader 26 supplies hydraulic fluid to and receives expended or excessive hydraulic fluid from hydraulic control system 60. Referring to FIG. 8, hydraulic fluid flows from skid-steer loader 26 as main flow 62. Main flow 62 is directed into flow divider 64. In an exemplary embodiment, flow divider is a Prince model RD 575 constant volume priority divider.

Flow divider 64 divides hydraulic fluid into primary flow 66, which comprises most of direct flow 62, and secondary flow 68. Primary flow 66 is directed to saw motor 44 and returns to skid-steer loader 26 via return line 69. In an exemplary embodiment, saw motor 44 is a Parker gear motor. As primary flow 66 is directed through saw motor 44, saw motor 44 powers arbor shaft 42, which causes blade 33 to rotate, as depicted in FIG. 3. In an exemplary embodiment, hydraulic control system 60 supports and substantially maintains a flow rate sufficient to rotate blade 33 of rotary saw 32 at a rate of approximately 2,300-2,700 rotations per minute. Primary flow 66 may also route hydraulic flow through check valve 48. Check valve 48 allows blade 33 to gradually reduce rotational speed after hydraulic flow is cut off by an operator.

Secondary flow 68 is directed to flow control device 70. By selectively dividing secondary flow 68 into controlled flow 76 and excess flow 78, flow control device 70 permits adjustment of the rate of hydraulic flow through control valve 72 which, in turn, controls the output of orbital motor 84 and the rate of movement of hydraulic cylinder 46. Hydraulic flow which is not directed to control valve 72 is returned to skid-steer loader via return line 67 as excess flow 78. Flow control device 70 may be controlled manually, electronically, or by a load-sensing circuit. In an exemplary embodiment, flow control device 70 is a Brand Hydraulics model EC-12-01 electronic flow control controller. Flow control device 70 may be in electronic communication with control box 71. Although control box 71 may be located in any number of places on cutter 20 or skid-steer loader 26, control box 71 is generally mounted in cab 74 of skid-steer loader 26.

From flow control device 70, controlled flow 76 is directed to control valve 72. Control valve 72 may contain any number of spools that divide controlled flow 76 into a corresponding number of circuits. By dividing controlled flow 76 into multiple circuits downstream of flow control device 70, control valve 72 provides a hydraulic configuration that permits multiple components of cutter 20 to be powered by a selectively variable rate of hydraulic flow. In an exemplary embodiment, control valve 72 is a Gresen V20 solenoid-controlled, dual-spool, closed center hydraulic control valve that divides controlled flow 76 into two circuits 80, 82.

Circuits 80, 82 created by control valve 72 are used to route hydraulic flow to orbital motor 84 and hydraulic cylinder 46. As depicted in FIG. 8, first circuit 80 routes hydraulic flow to orbital motor 84 (which powers extension and retraction of boom housing 38 along boom 22) and second circuit 82 routes hydraulic fluid to hydraulic cylinder 46 (which controls the depth of the rotary saw blade 32). In an exemplary embodiment, orbital motor 84 is a Char-Lynn J-series hydraulic motor and hydraulic cylinder 46 is a Columbus Hydraulics double-acting cylinder.

A typical front-end loader similar to skid-steer loader 26 as depicted in FIG. 1 supplies hydraulic control system 60 with approximately twenty-six and one-half gallons of hydraulic fluid per minute in “high flow” mode. In an exemplary embodiment, first circuit 80 and second circuit 82 require a total of approximately six gallons of hydraulic fluid per minute. Therefore, hydraulic control system 60 has approximately twenty and one-half gallons of hydraulic fluid available as primary flow 60 for powering saw motor 44, saw motor 44 being the major consumer of hydraulic power.

To achieve a proper allocation of hydraulic fluid between primary flow 66 and secondary flow 62, hydraulic fluid from skid-steer loader 26 is apportioned by flow divider 64. Generally, flow divider 64 is adjustable so that the flow rate of primary flow 66 and secondary flow 68 can be increased or decreased as desired. To allow the flow rate of primary flow 66 and secondary flow 68 to be adjusted, flow divider 64 may be a constant volume priority divider. In an exemplary embodiment, flow divider 68 supplies saw motor 44 with the majority of the hydraulic flow.

Referring to FIG. 8, primary flow 64 is directed to saw motor 44. To maximize the power and rotational speed of blade 33, saw motor 44 may be any number of motors having a capacity to displace substantially all of primary flow 64 while rotating blade 33 at a desired rate. In an embodiment, saw motor 44 has a displacement capacity of approximately 1.4 cubic inches to about 2.0 cubic inches. In an exemplary embodiment, saw motor 44 has a displacement capacity of approximately 1.7 cubic inches. The desired rotational speed of blade 33 may depend a number of factors, such as, for example, the material used to make the paving surface being cut by cutter 20, the state of hardness of the material, whether the material being cut is fully set or still curing, the type of blade 33 being used, and the diameter of blade 33. In an exemplary embodiment, saw motor 44 uses a hydraulic flow rate of approximate twenty gallons per minute to rotate blade 33 having a twenty-inch diameter at a rate of approximately 2,300-2,700 rotations per minute.

Referring to FIGS. 2-4, saw motor 44 rotates blade 33 by spinning arbor shaft 42 operably connected to saw motor 44 and blade 33. As arbor shaft 42 spins, arbor shaft 42 causes blade 33 to rotate. In an exemplary embodiment, arbor shaft 42 has a one-inch diameter and spins on flange bearings 45 in linkage system 47 attached to hydraulic cylinder 46. Linkage system 47 pivots on pillow block bearings 49 that can be adjusted so that blade 33 cuts parallel to boom 22.

To achieve a desired rotational rate of blade 33, saw motor 44 may be rotationally engaged to arbor shaft through any number of mechanisms. In an exemplary embodiment, flex coupler 51 couples saw motor 44 to arbor shaft 42. Flex coupler 44 produces a 1:1 gear ratio between saw motor 44 and arbor shaft 42. In another embodiment, arbor shaft 42 is driven by at least one belt, such as, for example, a single-cog belt or multiple-cog belts.

Depending upon the circumstances, such as the type of material used to make the paving surface being cut, it may be at times desirable to vary the rotational speed of blade 33. Alternatively, it may be desirable to select blades 33 having different diameters (which affects the rotational speed of blade 33) while maintaining a constant rotational speed. The rotational speed of rotary cutting blade 33 can be variably controlled in any number of ways. In an exemplary embodiment wherein arbor shaft 42 is gear-driven, rotational speed of blade 33 can be variably controlled by altering the displacement capacity or the gear ratio of saw motor 44, or both. Alternatively, saw motor 44 can be replaced with a different saw motor having a different displacement capacity, gear ratio, or both. In an embodiment of the present invention wherein blade 33 is belt-driven, the rotational speed of blade 33 can be variably controlled by changing the size of the pulleys mounted on saw motor 44 and arbor shaft 42. In another embodiment, flow divider 64 can be modified so as to reduce or increase the flow of hydraulic fluid through flow divider 64.

As depicted in FIG. 8, hydraulic fluid that is not directed to saw motor 44 as primary flow 66 can be directed to orbital motor 84 and hydraulic cylinder 46 as secondary flow 68. Orbital motor 84 controls the travel of trolley 24 along boom 22. Hydraulic cylinder 46 controls the depth of rotary saw 32 relative to boom 22 and the paved surface being cut.

In general, orbital motor 84 can retract or extend trolley 22 by engaging a chain-and-sprocket system connected to boom housing 38. Specifically, as secondary flow 68 is directed to orbital motor 84, orbital motor 84 drives a series of gears that cause chain 88 to pull boom housing 38 in either the extension or retraction directions. To achieve optimal performance of cutter 20, orbital motor 84 should provide sufficient output to retract trolley at a selected rate from distal end 34 to proximal end 36 while blade 33 cuts a paved surface. Orbital motor 84 may also be selected that can extend trolley 24 from proximal end 36 to distal end 34 while blade 33 cuts a paved surface. In an embodiment, orbital motor 84 has an output of between about six-hundred and seven-hundred rotations per minute when supplied with about five gallons of hydraulic fluid per minute. In an exemplary embodiment, orbital motor 84 has an output of about six-hundred fifty-seven rotations per minute when supplied with about five gallons of hydraulic fluid per minute.

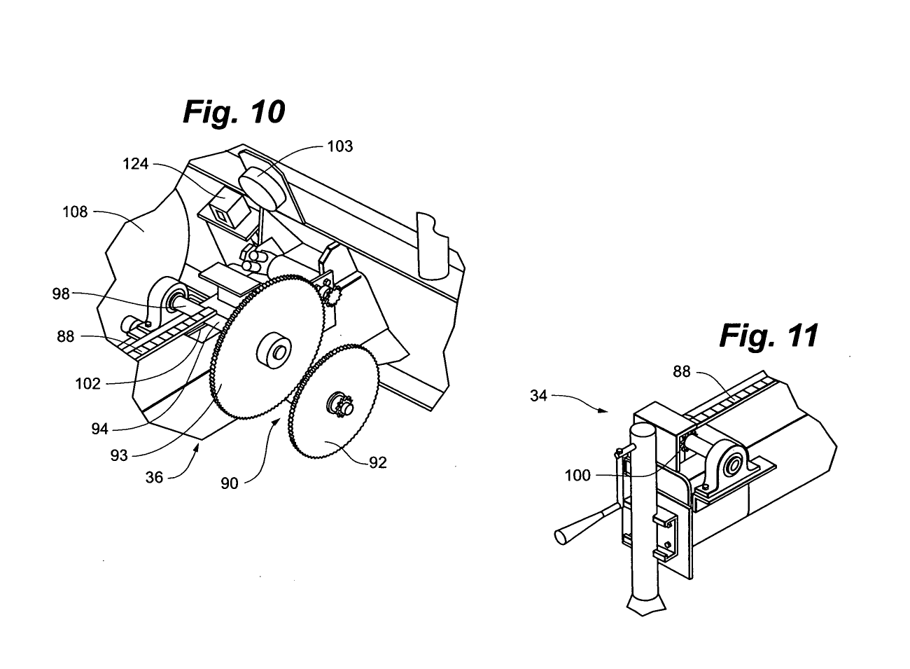

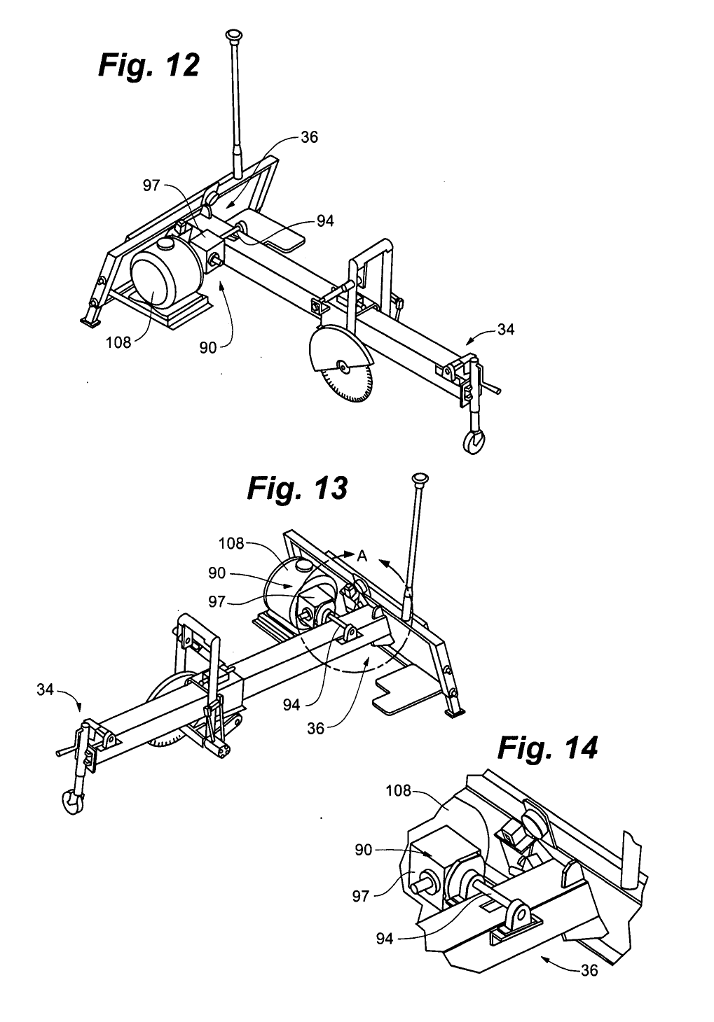

In operation, trolley 24 should maintain a relatively slow rate of travel of blade 33 through the paved surface being cut. Since orbital motor 84 may have an output of around six-hundred fifty-seven rotations per minute when supplied with around five gallons of hydraulic fluid per minute, a gear reduction is often required to reduce the rate of travel of trolley 24. The desired speed reduction can be achieved in any number of ways. Generally, cutter 20 comprises gear reduction system 90 to achieve a desired rate of travel of trolley 24. In an exemplary embodiment, cutter 20 uses a combination of gears to produce a gear reduction ratio of 42:1. Referring to FIGS. 9-10, first reduction gear 92 provides a primary reduction of 7:1. Second reduction gear 93 provides a secondary reduction of 6:1 and is connected to idler shaft 94. The total reduction from orbital motor 84 to idler shaft 94, therefore, is 42:1. To protect gear reduction system 90 from damage and the operator of cutter from harm, gear reduction system 90 may be covered with safety shield 96. In another embodiment, gear reduction can be achieved with a gear box 97. Use of gear box 97 in place of reduction gears 92, 93 may reduce the number of exposed moving parts, eliminate the need for a safety shield, and increase the durability of cutter 20. Use of gear box 97 may also simplify the process of assembling cutter 20 since orbital motor 84 can be attached directly to gear box 97.

Orbital motor 84 for powering trolley 24 may be any number of hydraulically powered motors. The selection of an appropriate orbital motor 84 normally depends on a number of factors. For example, orbital motor 84 producing a relatively small number of rotations per minute requires less gear reduction to achieve the final desire drive speed. The smaller number of rotations, however, results in less available torque since the gear reduction ratio is reduced. Orbital motor 84 should have the ability to handle high-radial shaft loads and be compact in size. Orbital motor 84 should also have the ability to power chain drive system 98 at an appropriate rate over a range of hydraulic flow rates. Specifically, orbital motor 84 should be able to provide different levels of power to the gear-and-chain system within this range. In one embodiment, orbital motor 84 variably provides power to the drive gear-and-chain system when supplied with hydraulic input in a range of one-third of one gallon per minute to about ten gallons per minute. In an exemplary embodiment, orbital motor 84 variably provides power to the drive gear-and-chain system of cutter 20 when supplied with hydraulic input in a range of about one gallon per minute to about six gallons per minute.

Orbital motor 84 drives trolley 24 by powering gear reduction system 90 or gear box 97 that engages chain drive system 98. Referring to FIGS. 9-11, chain drive system 98 has an end of chain 88 attached to the top of each end of trolley 24. Chain 88 wraps around idler sprocket 100 located at distal end 34 of boom 22 and around drive sprocket 102 located at proximal end 36 of boom 22. Between the idler and drive sprockets 100, 102, chain 88 extends above boom 22 and drapes inside the interior cavity of boom 22. An adjustable tensioner can be attached to one end of chain 88 to limit the amount of drape under boom 22. To protect the operator of cutter 20 or other individuals, reduce the risk of interference with the chain drive system 98, and protect chain 88 from damage, the top of chain 88 may also be covered with a shield. Generally, chain 88 may be any type of linkage device suitable for use in cutter. In an exemplary embodiment, chain 88 is a heavy-roller chain.

In operation, orbital motor 84 engages chain drive system 98 in either the direction of extension or retraction, which causes chain 88 to pull trolley 24 in the selected direction. The direction in which chain 88 pulls trolley 24 is determined by the direction in which an output shaft from orbital motor 84 rotates, which is operator selectable. Trolley 24 moves as boom housing 38 slides along boom 22. Generally, the inside surfaces of boom housing walls 50 are coextensively positioned around boom 22 to minimize unintended wiggle of trolley 24. This helps establish a snug fit between boom housing 38 and boom 22 that can reduce the risk of blade 33 becoming immovably wedged in the paved surface during operation. Due to friction, however, this snug fit can also impede the movement of trolley 24 to along boom 22. To increase ability of trolley 24 to travel along boom housing 38 during operation while maintaining a snug fit, the inside surfaces of boom housing walls 50 or the outside surfaces of boom walls 52 can be lined with a material having a low coefficient of friction. The type of material and thickness of the material can be varied to accommodate limitations such as availability, cost, and durability.

In an exemplary embodiment, the inside surfaces of boom housing walls 50 are at least partially lined with plates 54 made from a polymer, such as perlon or nylon, having a thickness of approximately one-half inch. In another embodiment, the outside surfaces of boom walls 52 are at least partially lined with a polymer, such as perlon or nylon, having a thickness of approximately one-half inch. Plates 54 may be loosely disposed between boom housing walls 50 and boom walls 52 and captured in such disposition by inwardly directed flanges formed on boom housing walls 50. Plates 54 may be readily replaced in such disposition when worn. In another embodiment, both the inside surfaces of boom housing walls 50 and the outside surfaces of boom walls 52 are at least partially lined with a polymer, such as perlon nylon. In another embodiment, both the inside surfaces of boom housing walls 50 and the outside surfaces of boom walls 52 are at least partially lined with different materials.

An important feature and advantage of the present invention is the ability of hydraulic control system 60 of cutter 20 to be manipulated by an operator of skid-steer loader 26 to control the rate of retraction and extension of trolley 24 and the depth of blade 33 within the surface being cut. Referring to FIG. 8, control over the cutting rate and cutting depth is achieved by integrating flow control device 70 and control valve 72 into controlled flow 76. Generally, flow control device 70 controls the rate at which orbital motor 84 and hydraulic cylinder 46 can be operated, while control valve 72 controls how orbital motor 84 or hydraulic cylinder are operated. Specifically, flow control device 70 may be electronically linked to a controller, such as a manually-operated electronic flow controller or a load-sensing circuit. Depending upon the electronic information received from the electronic flow controller or load-sensing circuit, flow control device increases, decreases, or holds constant the rate of hydraulic flow. For example, when an increase in hydraulic flow is desired to increase the rate of extension or retraction or trolley 24 or the rate at which blade 33 is raised or lowered, flow control device 72 increases the volume of controlled flow 76 and decreases the volume of excess flow 78. Alternatively, when a decrease in hydraulic flow is desired to decrease the rate of extension or retraction or trolley 24 or that rate at which blade 33 is raised or lowered, flow control device 72 decreases the volume of controlled flow 76 and increases the volume of excess flow 78. In an exemplary embodiment, flow control device 70 is controlled by an electronic flow control device located in control box mounted in cab 74 of skid-steer loader 26. This allows an operator to manually adjust the speed of trolley 24 and hydraulic cylinder 46. In another embodiment, flow control device 70 is controlled by a load-sensing circuit. This allows the speed of trolley 24 and hydraulic cylinder 46 to be automatically adjusted by cutter 20 in response to changes in pressure or resistance as blade 33 effects a cut.

When this signal is adjusted, such as by manipulation of control box 71, a valve within flow control device 70 is opened or closed to port more or less hydraulic fluid to control valve 72, thereby increasing or decreasing the speed of trolley 26 or depth control (by movement of hydraulic cylinder 46) by a corresponding amount. In an embodiment of the present invention, the speed of trolley 26 can be adjusted between about zero feet per minute and about thirty feet per minute. In an exemplary embodiment, the speed of trolley 26 can be adjusted between about zero feet per minute and about fourteen feet per minute. This enables the trolley to be moved slowly during retraction (cutting) while maximizing trolley speed during extension (non-cutting/repositioning). Alternatively, fluid pressure gauge 103 located in primary flow 66 circuit can be used to set the speed of retraction of trolley 26 without departing from the spirit of scope of the present invention.

While flow control device 70 allows the rate of hydraulic flow to orbital motor 84 and hydraulic cylinder 46 to be selectively controlled, control valve 72 allows orbital motor 84 and hydraulic cylinder 46 to be selectively actuated. Generally, control valve 72 is electronically linked to existing controls in cab 74 of skid-steer loader 26. Specifically, the controls are able to relay electronic signals to control valve 72. These signals dictate which circuits 80, 82 should be actuated.

Control valve 72 may, therefore, be any type of valve having the ability to simultaneously control two or more hydraulic circuits. In an exemplary embodiment, control valve 72 is a closed-center, solenoid-controlled, dual-spool valve. Depending upon the electronic signal received from the controls, spool valves 79, 81 within control valve 72 may be shifted in a selected direction. The directions in which spool valves 79, 81 are shifted determine the direction of hydraulic flow through circuits 80, 82 which, in turn, determines the direction of trolley 24 and whether rotary saw 32 is raised or lowered. When spool valves 79, 81 are centered, hydraulic flow through the corresponding circuits 80, 82 and movement of the corresponding components are halted.

By manipulating the controls in cab 74 which are electronically linked to control valve 72, an operator is able to select which circuits 80, 82 receive hydraulic flow and adjust the direction of hydraulic flow through circuits 80, 82. Specifically, the direction of the hydraulic flow can be reversed by using the controls to change the orientation of spool valves 79. 81 is control valve 72. This allows an operator to extend and restrict trolley 24 and raise or lower rotary saw 32. Referring to FIG. 8, an operator may choose to actuate spool valve 79 of control valve 72 that actuates primary circuit 80. When primary circuit 80 is actuated, hydraulic flow powers orbital motor 84 and causes trolley 24 to extend or retract along boom 22. When the orientation of spool valve 79 within control valve 72 is changed, hydraulic flow through primary circuit 80 is reversed and the direction of trolley 24 changes. An operator is thereby able to both retract and extend trolley 24. When spool valve 79 of primary circuit 80 is centered, trolley 24 is halted at its current position.

An operator may also choose to actuate spool valve 81 of control valve 72 that actuates secondary circuit 82. When secondary circuit 82 is actuated, hydraulic flow powers hydraulic cylinder 46 and causes rotary saw 32 to be raised or lowered. By changing the orientation of spool valve 81 within control valve 72 an operator can reverse the hydraulic flow through secondary circuit 82, thereby raising or lowering rotary saw 32. When spool valve 81 of primary circuit 82 is centered, rotary saw 32 is held at a desired depth. Referring to FIG. 8, restrictor valve 104 may also be incorporated in second circuit 82 to control the rate at which hydraulic cylinder 46 lowers blade 33. In an exemplary embodiment, restrictor valve 104 can be adjusted to the desired flow rate in the downward direction, but does not affect the flow rate in the upward direction.

To permit an operator to judge the depth of blade 33 in the paved surface being cut, trolley 26 may also have a depth control gauge. Generally, depth control gauge may be any number of devices that visually, electronically, acoustically, or otherwise display the depth of blade 33 relative to boom 22 or the paved surface being cut. In an exemplary embodiment, cutter 20 has a color-coded gauge positioned parallel to hydraulic cylinder 46. As the depth of blade 33 is adjusted, a different color from a fixed spectrum of controls disposed to the color-coded gauge is mechanically covered or uncovered to indicate depth.

The hydraulic flow through first circuit 80 (responsible for trolley speed) and second circuit 82 (responsible for depth of blade 33) are typically adjusted by separate controls. Primary circuit 80 and secondary circuit 82 are also typically adjusted such that circuits 80, 82 are not simultaneously actuated. Cutter 20 may easily be configured, however, so that primary and secondary circuits 80, 82 are simultaneously controlled or controlled by a different system of controls. For example, first circuit 80 and second circuit 82 may be controlled the use of control box 71, such as controls hydraulic flow through flow control device 70. Alternatively, hydraulic flow in first circuit 80 or second circuit may be controlled through the use of a pressure sensor integrated into the controlled flow. In either of these embodiments, control box 71 and pressure sensor may be positioned in any number of locations, such as inside or outside of cab 74 of skid-steer loader 26 or on cutter 20.

Cutter 20 optionally includes a number of other features that may enhance or improve the operation of cutter 20. Referring to FIGS. 1-2, 4 and 9, cutter 20 may have spring-loaded mast 120. As depicted in FIG. 4, the hydraulic hoses of hydraulic control system 60 can be attached to spring 122 disposed to spring loaded mast 120. Alternatively, the hydraulic hoses of hydraulic control system 60 can be attached directly to spring-loaded mast 120. Although spring-loaded mast 120 may be positioned in a number of locations, spring-loaded mast 120 is generally disposed to attachment plate 28. By connecting the hydraulic hoses to spring 122 or spring-loaded mast 120, the likelihood of interference between trolley 24 or blade 33 and hydraulic hoses as boom housing 38 moves along boom 22 can be reduced.

In an exemplary embodiment, cutter 20 has spring-loaded mast 120 and spring 122. When trolley 24 is located in an extended position at distal end 34 of boom, the hydraulic hoses pull on spring 122 while spring 122, in turn, pulls on spring-loaded mast 120. These pulling forces cause spring 122 to expand and the top of spring-loaded mast 120 to bend from an upright position toward distal end 34 of boom 22. As trolley 24 is retracted from distal end 34 of boom 22 toward proximal end 36 of boom 22, spring 122 contracts and spring-loaded mast 120 returns to an upright position. These actions by spring 122 and spring-loaded mast 120 cause the hydraulic hoses to be dragged away from trolley 24, thereby removing the hydraulic hoses from the pathway of blade 33 and reducing the likelihood that the hydraulic hoses might interfere with trolley 24. In an embodiment, cutter 20 may also include a support bar (not shown) to which the hydraulic hoses can be movably attached. The support bar elevates the hydraulic hoses so that the hydraulic hoses do not rest on the surface being cut as trolley 24 travels along boom 22.

Cutter 20 may also include a component that facilitates alignment of cutter 20 with a desired cutting path, such as in cutting control joints in concrete. Referring to FIG. 3, cutter 20 may have a laser alignment system. The laser alignment system has a laser emitter 124 that emits a beam substantially aligned with the cutting path of blade 33. Laser emitter 124 may be disposed to boom 22, attachment plate 28, or other appropriate component of cutter 20. Laser light system can be used in a variety of situations, such as, for example, aligning a cutting pathway with existing control joints. When cutter 20 is used to create cut control joints, a laterally directed rod can also be attached to a side of boom 22. Based upon the chosen length of the rod, an operator can easily space control joints on a sidewalk at a desired interval by aligning the distal end of the rod with the previous cut.

To limit overheating of blade 33 during operation, cutter 20 can also be equipped with a coolant delivery system. Referring to FIGS. 2-3, the coolant delivery system generally has pump 106, tank 108, and at least one hose and one nozzle. In operation, pump 106 directs a coolant such as water coolant is drawn from tank 106 through a hose and sent to a nozzle. The nozzle is optimally positioned so as to spray coolant onto at least one side of blade 33. The coolant delivery system can also be configured so as to spray coolant onto both sides of blade 33 by positioning a nozzle on each side of blade 33. In an exemplary embodiment, a twelve-volt pump 106 supplies coolant from a thirty-five-gallon water tank 108 to two water nozzles situated on opposite sides of blade 33. To allow an operator to control the amount of water delivered to blade 33, the coolant delivery system may also include an adjustable pressure regulator electrically connected to a control switch located in cab 74 of skid-steer loader 26. A small valve between pump 106 and the nozzles can also be used to control the amount and rate of coolant delivered to blade 33.

Similarly, cutter 20 may also be adapted to deliver a fluid to the paved surface being cut. In an exemplary embodiment, a spray nozzle is attached to cutter 20, such as rotary saw 32 of cutter 20, so that an operator can simultaneously apply a fluid to the paved surface while cutting the paved surface. The fluid may comprise a chemical that retards the rate at which concrete cures or some other suitable reagent, a solution, a solvent, a carrier, a surfactant, a dispersion, a dispersant, a mixture, and a lubricant

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the present invention.

What is claimed:

1. A powerable cutter removably mountable to an attachment area of a vehicle that can position the cutter to cut a slab, the cutter comprising:
a boom having a distal end and a proximal end, the proximal end being attached proximate the attachment area; and
a trolley being selectively positionable between the proximal end and the distal end of the boom at a controllable variable speed while carrying a selectively powered rotary saw being selectively positionable to a depth relative to the boom to at least partially cut through the slab.

2. The cutter of claim 1, wherein the cutter is hydraulically actuated.

3. The cutter of claim 2, wherein the trolley comprises a boom housing slidably coupled to the boom.

4. The cutter of claim 3, wherein the boom housing has an inner surface adapted to substantially coextensively conform around a portion of an outer surface of the boom.

5. The cutter of claim 4, wherein the boom housing comprises a first material and the inner surface comprises a second material, the first material having a coefficient of friction greater than a coefficient of friction of the second material.

6. The cutter of claim 2, further comprising a cab-mounted control box in electrical communication with a flow control device having a control valve, wherein manipulation of the control box adjusts the speed of the trolley and the depth of the rotary saw relative to the boom.

7. The cutter of claim 6, further comprising a saw motor operably connected to the rotary saw with a linkage device.

8. The cutter of claim 7, wherein the linkage device is gear-driven.

9. The cutter of claim 7, wherein the linkage device is belt-driven.

10. The cutter of claim 2, further comprising an orbital motor operably connected to the trolley.

11. The cutter of claim 2, further comprising a system for applying a coolant to a surface of the rotary saw.

12. The cutter of claim 2, further comprising a system for applying a substance to a surface of the slab that slows a rate of drying of the slab, the substance being selected from a group consisting of a reagent, a solution, a solvent, a carrier, a surfactant, a dispersion, a dispersant, a mixture, and a lubricant.

13. The cutter of claim 2, further comprising a laser alignment device that illuminates a cutting path substantially followed by the rotary saw.

14. The cutter of claim 2, further comprising a jack stand located proximate the distal end of the boom.

15. The cutter of claim 2, further comprising a resiliently flexible spring-loaded mast located proximate the proximal end of the boom.

16. The cutter of claim 15, wherein the spring-loaded mast is attached to a plurality of hydraulic hoses.

17. The cutter of claim 16, wherein a spring is disposed intermediate the spring-loaded mast and the plurality of hydraulic hoses.

18. A method for cutting a slab with a powerable cutter, the method comprising the steps of:
positioning a boom over the slab, the boom having a proximal end and a distal end;
selectively positioning a trolley mounted on the boom relative to the slab for effecting a first cut;
selectively powering a rotary saw carried by the trolley;
selectively positioning the saw relative to the slab to effect the first cut at a selected depth; and
retracting the trolley toward the proximal end at a controllable variable speed, thereby effecting the first cut at a selected speed.

19. The method of claim 18, further comprising the step of extending the trolley toward the distal end at a controlled variable speed, thereby positioning the rotary saw to effect a second cut.

20. The method of claim 18, further comprising the step of manipulating a cab-mounted control box in electrical communication with a flow control device having a control valve, wherein manipulation of the control box adjusts the speed of the trolley and the depth of the rotary saw relative to the slab.

21. The method of claim 18, further comprising the step of illuminating a cutting path of the rotary saw through the slab with a laser alignment device.

22. The method of claim 18, further comprising the step of applying a coolant to a surface of a blade of the rotary saw.

23. The method of claim 18, further comprising the step of applying a substance to a surface of the slab that slows a rate of drying of the slab, the substance being selected from a group consisting of a reagent, a solution, a solvent, a carrier, a surfactant, a dispersion, a dispersant, a mixture, and a lubricant.

24. The method of claim 18, further comprising the step of manipulating a jack stand positioned proximately to the distal end of the boom, the jack stand supporting the cutter on the slab or a surface adjacent to the slab, the boom being positioned over the slab.

25. The method of claim 18, wherein the cutter is hydraulically actuated.

26. The method of claim 18, wherein the proximal end of the cutter is mountable to an attachment area of a vehicle that can position the cutter to transversely cut the slab.
